(19) United States
(12) Patent Application Publication
(10) Pub. No.: US 2007/0044079 A1
(43) Pub. Date: Feb. 22, 2007

(54) A system and method for compiling a description of an electronic circuit to instructions adapted to execute on a plurality of processors

(75) Inventors: SUBBU GANESAN, SARATOGA, CA (US); LEONID ALEXANDER BROUKHIS, FREMONT, CA (US); RAMESH NARAYANASWAMY, PALO ALTO, CA (US); IAN MICHAEL NIXON, SUNNYVALE, CA (US); THOMAS HANNI SPENCER, SUNNYVALE, CA (US)

Correspondence Address: PATENTRY, P.O. BOX 151616, SAN RAFAEL, CA, 94915-1616, US

(73) Assignee: THARAS SYSTEMS INC., Santa Clara, CA (US)

(21) Appl. No.: 11/427,945

(22) Filed: Jun. 30, 2006

Related U.S. Application Data
(63) Continuation-in-part of application No. 11/307,198, filed on Jan. 26, 2006.
(60) Provisional application No. 60/595,057, filed on Jun. 2, 2005.

(51) Int. Cl. G06F 9/45

(52) U.S. Cl. 717/136

(57) ABSTRACT

A method for verifying electronic circuit designs in anticipation of fabrication by compiling a hardware description to instructions for processors which are scalably interconnected to provide simulation and emulation, having deterministically scheduled transfer of circuit signal values among the large number of circuit evaluation processors and scheduled and assigned instructions to the processors in an optimal manner.

### CROSS-REFERENCE TO RELATED APPLICATIONS

The present application claims the benefit of priority under 35 USC .sctn. 119(e) from U.S. provisional patent application 60/595,057 filing date Jun. 2, 2005 first named inventor Ganesan, titled: “Massively parallel platform for accelerated verification of hardware and software.”

The present application is a continuation in part of U.S. patent application Ser. No. 11/307198 filing date 2006 Jan. 26, first named inventor Ganesan, titled: “A scalable system for simulation and emulation of electronic circuits using asymmetrical evaluation and canvassing instruction processors”.

### BACKGROUND OF THE INVENTION

1. Field of the Invention

The present invention relates to the electronic design of integrated circuits, and more specifically to a method for the hardware accelerated functional verification of a target integrated circuit design modeled in a hardware description language such as Verilog, VHDL, System Verilog, or System C.

2. Related Art

Functional verification is one of the steps in the design of integrated circuits. Functional verification generally refers to determining whether a design representing an integrated circuit performs a function it is designed for. The inventors have previously disclosed functional verification systems (U.S. Pat. Nos. 6,691,287, 6,629,297, 6,629,296, 6,625,786, 6,480,988, 6,470,480, and 6,138,266) in which a target design is partitioned into many combinational logic blocks connected by sequential elements. The state tables corresponding to the logic blocks are evaluated and stored in multiple random access storage devices (RASDs). Such an approach may have several disadvantages. For example, some logic blocks may exceed the convenient width of typical RASDs. Some target designs may contain functional blocks such as user specific memories, or simply require many more logic blocks and internal signals than can be practically accommodated. Accordingly, the embodiments of previous patents may not be suitable in some environments. Furthermore conventional verification environments do not scale with the rapidly expanding size of chips and complexity of designs deploying reusable silicon intellectual property. Thus it can be appreciated that what is needed is a system to scale a hardware simulation system for electronic circuit design which efficiently uses a large number of processors physically distributed among multiple units which requires accommodation of transfer delay. Accordingly, what is needed is a method of compiling a hardware description to execute in a scalable architecture for a plurality of processors with non-uniform transfer delay.

### SUMMARY OF THE INVENTION

The present invention is a method embodied in a compiler for translating a hardware description of an electronic circuit to evaluation instructions and optimizing the instructions to efficiently utilize a plurality of processors distributed across a plurality of units.

### DESCRIPTION OF DRAWINGS

FIG. 1A is a block diagram of a system comprising two evaluation units.

FIG. 1B is a block diagram with further detail of an evaluation unit.

FIG. 2 is a schematic of the interconnect of a system.

FIG. 3 is a schematic of the backplane interconnect of a module.

FIG. 4 is a block diagram of an evaluation module unit.

FIG. 5 is a flow diagram of the major steps of compiling a design description.

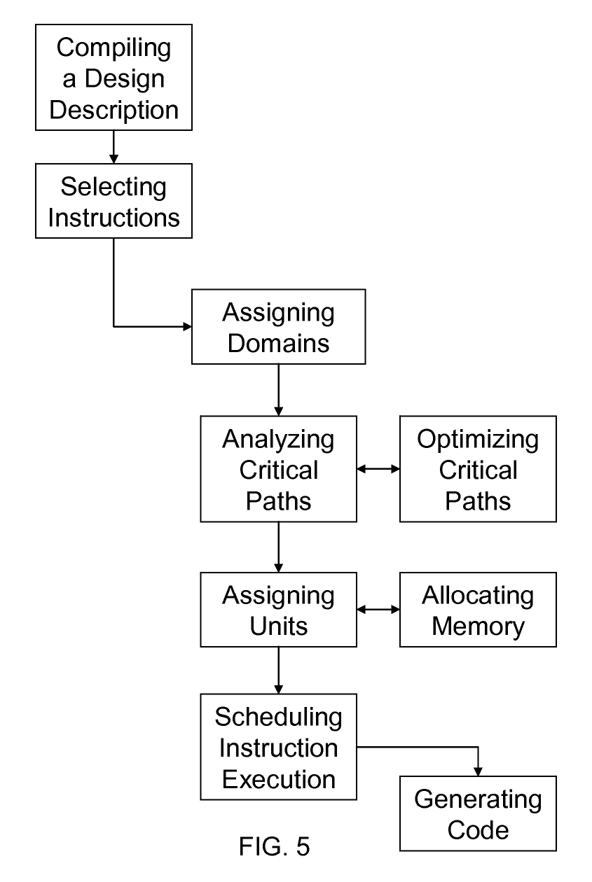

### DETAILED DESCRIPTION

The present invention is a system for verifying electronic circuit designs in anticipation of fabrication by simulation and emulation. The system uses
a plurality of evaluation processors, and
a software product compiler, tangibly encoded on a computer readable storage device as instructions controlling a computer system to perform the following method: analyzing a circuit description for inherent circuit value data transfer activity among its elements, translating the circuit description to evaluation processor instructions, assigning the evaluation processor instructions to certain storage devices associated with certain evaluation processors to optimize circuit value data transfer, generating canvassing processor instructions to ensure that results from certain evaluation processors are transferred to certain other evaluation processors according to the circuit description, scheduling the execution of evaluation processor instructions and canvassing processor instructions to avoid deadlock, and transferring certain evaluation results to the host computer interface.

The present invention further comprises a method for scalably emulating the electronic circuit description, tangibly embodied as program instructions on a computer-readable medium controlling the operation of one or more processors, the method comprising the steps of

executing program instructions on a plurality of evaluation processors and on a plurality of canvassing processors resulting in the transfer of results of selected evaluation processor evaluations available to and read by selected evaluation processors to perform further evaluations; and

updating one or more circuit signal values,

wherein updating in an embodiment comprises the steps of

reading a circuit signal value,

transferring a circuit signal value, and

storing a circuit signal value data in circuit signal value storage media;

suspending the execution of evaluation instructions until data is available, wherein suspending comprises the steps of checking signal value transfer storage for availability of all the data necessary for executing an evaluation instruction and enabling the execution of the evaluation instruction only when the data necessary for executing the evaluation instruction is available, and
controlling the transfer of signal values,
wherein controlling comprises the steps of
composing canvassing instructions to pass the results of a selected evaluation processor to those evaluation processors which require those results to execute their evaluation instructions; and
blocking the execution of canvassing instructions,
wherein blocking comprises the steps of checking the reading circuit data value transfer storage for unoccupied storage resource and enabling the execution of the canvassing instruction only when the reading circuit has unoccupied transfer storage resource;

compiling one or more hardware descriptions to processor instructions, wherein compiling comprises
translating the electronic circuit description into executable evaluation instructions, and
analyzing the circuit value transfers inherent to the electronic circuit description;
scheduling the execution of evaluation instructions in a plurality of processors, wherein scheduling comprises
assigning evaluation instructions among evaluation processors to optimize circuit value transfers inherent in the electronic circuit design; and
loading the evaluation instruction storage so that a first evaluation instruction is executed after one or more second evaluation instructions on which the first evaluation instruction depends for signal value data input wherein first and second refer not to the process of execution but rather to the process of scheduling which is in reverse from outputs to inputs of the target circuit under simulation. It will be appreciated by those skilled in the art that the order of steps disclosed above may be changed or performed in parallel and the nature of the invention does not substantially depend on the sequence of steps disclosed for easier understanding of the present invention in an embodiment.

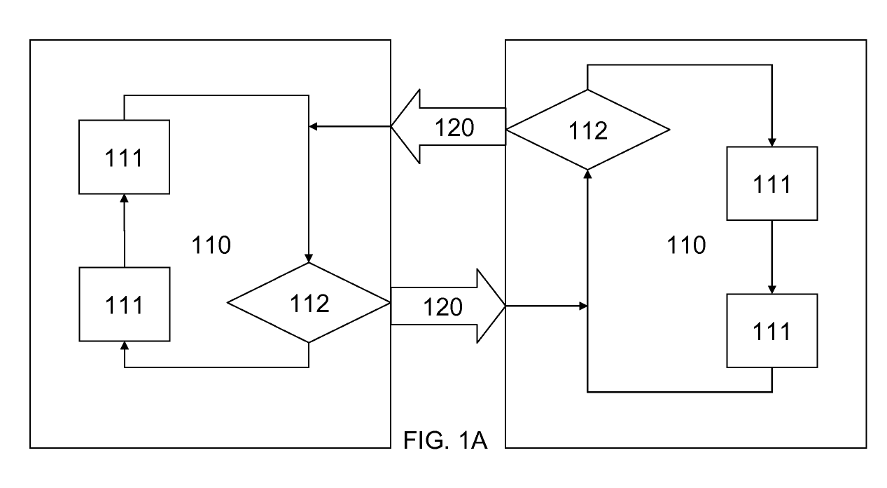

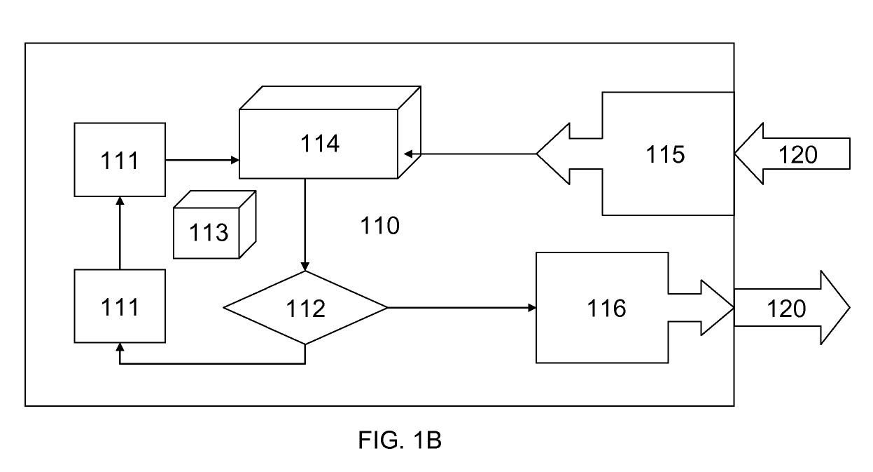

The present invention further disclosed in FIG. 1B is a system for verifying electronic circuit designs in anticipation of fabrication by simulation and emulation, comprising a first evaluation unit 110, the evaluation unit comprising: a host control interface, a plurality of evaluation processors 111, a plurality of canvassing processors 112, one or more circuit value data transfer circuits 116, one or more reading circuits 115 with associated transfer storage device, a circuit signal value storage unit 114, and instruction storage units 113. The problem being solved is that evaluations in one unit may depend on results of evaluation processors in the same evaluation unit and results of evaluation processors in a distant unit. Ensuring that prerequisite evaluations are performed early enough and transferred efficiently to optimize performance is beyond the scope of conventional verification systems.

The means for transferring an instruction or a circuit signal value among one or more processors, and one or more storage devices, include but are not limited to
wire,
printed trace,
bus,
fiberoptic cable,
transmission line, or
high-speed serial links.

Each evaluation processor is coupled to a plurality of other evaluation processors and through a canvassing processor to a medium coupled to all other evaluation processors in the system. The evaluation processor is further coupled to an instruction storage device and to a circuit value storage device. The evaluation processor is blocked from executing the instruction until all the necessary circuit values it requires as inputs are validated by a data checking circuit.

Each canvassing processor is coupled to the outputs of a plurality of evaluation processors and is coupled to certain transfer circuits of the medium. Under the control of a canvassing instruction scheduled by the compiler, it deterministically transfers a certain evaluated circuit signal value to a certain reading circuit coupled to a certain evaluation processor requiring the circuit signal value for further evaluation.

A model of a circuit written in a hardware description language is converted to instructions executable by a plurality of evaluation processors located on a plurality of evaluation units interconnected by canvassing processors. The present invention is embodied in the compiler which reads a hardware description language file and emits executable instruction files for the evaluation processors and the canvassing processors.

The present invention for compiling a circuit description to evaluation instruction for a plurality of evaluation processors within a plurality of units is a method comprising the steps of
selecting instructions adapted to execute on a plurality of evaluation processors,
clustering critical paths,
partitioning among a plurality of units, and
scheduling in reverse order.

The method of selecting instructions comprises building a table of available instruction templates appropriate to the evaluation processor, reading a hardware description of a circuit, and selecting instructions from available instruction templates according to speed, capacity requirements, and cost.

The method of clustering critical paths comprises creating an uncuttable group of related critical paths referred to as a fascine, assigning a cost to each communication edge between instructions, and tracing from the inputs of every register backward through instructions to an output of a register to identify a critical path with a greater number of communication edges than other paths.

The method of partitioning among a plurality of units comprises distributing a graph among units and ensuring that send and receive nodes are not on critical paths so as to balance computation across all available hardware resources and to minimize the overall critical path of the system. The method for maximizing parallelism comprises allocating instructions to processors in a balanced way and minimizing communication congestion on critical paths, keeping critical paths on the same node by assigning a cost to each communication edge between instructions that reflects criticality, generating an uncuttable group out of related critical paths referred to as a fascine.

The method of scheduling in reverse order comprises partitioning sending and receiving nodes on critical paths to be close rather than remote, scheduling an instruction for a sending node that must be remote from a receiving node earlier to allow propagation of results and ensuring that every send node is computed before its results are required at a receive node by scheduling in reverse order from outputs to inputs by synthesizing canvassing processor instructions.

The invention further includes a critical path optimizing method comprising assigning a cost value to every path, assigning a higher cost value to critical paths, assigning nodes to units, adding additional cost to paths which traverse unit to unit, computing the overall cost to determine if a critical path has been cut, and canceling the assignment if the effect is deleterious.

The invention further includes a unit assignment compacting method comprising levelizing evaluation instructions with respect to registers of the design, folding levels into flights constrained by the processor resources, inserting noops to space evaluation instructions within a fold, packing non-critical evaluation instructions to replace noops, grouping signals to be communicated into packets and encoding constraints on the netlist on the order in which packets are sent so as to ensure that the transmission ordering constraint imposed by the order in which signals are received does not conflict with other constraints on computing the order in which signal transmit whereby the compiler can schedule backward in time by grouping signals that are to be received together before determining exactly when they will be sent.

The invention further includes estimating transfer delay comprising one of uniform transfer delay or a plurality of quantized transfer delay comprising the steps of selecting an edge of a directed acyclic graph of the design pseudo-randomly, inserting a quanta of delay associated with breaking the path, determining if it becomes a critical path, measuring the topological interconnection between two critical paths, and assigning both paths to a fascine of critical paths with uniform transfer delay if the potential communication traffic is above average.

The invention further includes a meta function evaluation method comprising selecting an evaluation with input width greater than the capacity of a single processor, assigning the evaluation to a canvassing processor, setting an address of a canvassing processor storage to one of the possible input values of the evaluation, and storing a result of a meta function evaluation into the canvassing processor storage so as to cause retrieval of a result of a meta function evaluation from a canvassing processor storage by applying the evaluation inputs as the address of a canvassing processor storage.

Scheduler

The process of scheduling ensures that every send node is computed before its results are required at a receive node and to do so efficiently using available resources and with minimum delay. Sending nodes that must be remote from the receiving nodes would have to have their instructions scheduled earlier to allow propagation of results. By partitioning sending and receiving nodes on critical paths to be close physically, the present invention simplifies scheduling.

The present invention further comprises a method of coordinating the evaluation of logic and transfer of logic evaluation results on a bus to eliminate the possibility of deadlock wherein results cannot reach the logic which requires input data.

The present invention further comprises a method for managing unit to unit data transfer. This takes several cycles so transfer must be scheduled within a window ahead of when data is needed in a target unit. And only so many transfers can be handled “in transit” so some logic may be held for evaluation until bandwidth is available. The method is data driven, ie. not strictly synchronous, thereby tolerating some flexibility in promptness.

Initially every transfer is assumed at its worse case of being unit to unit. By assigning an edge to intra-unit transfer it simplifies the scheduling of the bus resource and reduces the time spent in transit. An edge on the critical path is randomly chosen to be placed within a unit. If the critical path is still critical repeat, else calculate another critical path. Stop optimizing when all of the physical resources for clusters in a unit are consumed. In conventional systems there is effectively one unit and therefore no method of optimizing assignment across units.

The present invention further comprises a method for bus management to avoid deadlock. A window of several cycles is required to propagate evaluation output data to the subscribing evaluation inputs. So scheduling of a data receive to drive a specific cluster, means a data transmit must be done with some error margin before that and the logic evaluation that drives the bus must occur in a cluster in an advanced time.

It is not the case that transfer can occur in any order. Suppose that nodes A and B are on unit X and need to send data to unit Y. It is not necessarily the case that the data from nodes A and B can be sent from X to Y in the same cluster. For example, maybe A drives B, so A needs to be evaluated before B. If we were scheduling forward in time, this would not be an issue. However, the compiler schedules backward in time, so it needs to group signals that are to be received together before it determines exactly when they will be sent. Therefore, to prevent deadlock, the unit assigner method comprises the step of grouping signals to be communicated into packets and encoding constraints in the netlist on the order in which packets are sent to make sure that transmission ordering constraint imposed by the order in which signals are received does not conflict with other constraints on computing the order in which signals transmit.

A deadlock is described if two units were to send too much data to each other without receiving anything, causing execution of both units to block each other. To prevent deadlock, the compiler method further comprises the step of tracking the amount of communication in progress from each unit to each other unit. If this amount might be bigger than the transmission FIFO memory, the compiler method further comprises the step of avoiding scheduling receives until transmits have been scheduled. If necessary, the compiler method further comprises modifying the netlist to allow a transmission to be scheduled immediately.

The present invention, embodied in a compiler, is a method of compiling a hardware description language description of a circuit to efficient parallel instructions for use in an array of processors comprises the steps of assigning instructions to processors, scheduling instructions in reverse order, optimizing critical paths in the topology of the design, and translating a hardware description of a circuit to a plurality of canvassing instructions and a plurality of evaluation instructions, whereby all evaluations are executed in advance of when their propagated results are required for subsequent evaluations and the circuit is simulated in the least time.

The present invention, a method of compiling a circuit description to processor instructions, comprises the following steps:

assigning evaluation instructions to certain processors, wherein assigning comprises the steps of: packing non-critical evaluation instruction efficiently to replace noops, balancing the load of evaluation instructions among processors, and minimizing data transfer volume and delay; scheduling instructions in reverse order,

wherein scheduling comprises the steps of:

levelizing evaluation instructions with respect to registers of the design,

folding levels into flights constrained by the processor resources, and

inserting noops to space evaluation instructions within a fold;

optimizing critical paths in the topology of the design,

wherein optimizing comprises the steps of:

estimating the effect of transfer delay on critical paths, assembling a fascine of critical paths to optimize data transfer, and breaking paths not included in a fascine of critical paths; and translating a hardware description of a circuit to evaluation and canvassing instructions.

The method further comprises the following steps:
assigning instructions to certain processors,
scheduling instructions in reverse order from output to inputs,
heuristically optimizing critical paths in the topology of the design, and
translating a hardware description of a circuit to instructions.

The optimizing method further comprises the steps of:

estimating the effect of a transfer delay on a critical path, assembling a fascine of critical paths to optimize data transfer, and breaking a path not included in a fascine of critical paths.

The transfer delay may be either estimated as uniform transfer delay or as a plurality of quantized transfer delay. The optimizing method comprises selecting an edge of a directed acyclic graph of the design pseudo-randomly, inserting a quanta of delay associated with breaking the path and determining if it becomes a critical path. The optimizing method further comprises measuring the topological interconnection between two critical paths and assigning them to a fascine of critical paths with uniform transfer delay if the potential communication traffic is above average.

Critical Path Reducer

The present invention further comprises a method of selecting and reassigning nodes or nets within the critical path of a design to efficiently assign physical resources and communication bandwidth.

The method of critical path merging comprising the steps of

1. For each node v, computing the length of longest path from v to register or primary output. Since the netlist is a directed acyclic graph, the longest path exists and is finite. Call this value the back rank of v.

2. Computing the length of longest path in the domain. This times the intraboard delay is a lower bound on the time required to evaluate the domain. This value is the goal path length.

3. For each node v working from inputs to outputs, computing an estimated execution time as follows:
wherein inputs of the domain have an estimated time of zero,
wherein non-inputs have an estimated execution time computed by
computing the maximum estimated execution time of any node that drive v's inputs,
adding either the intraunit or the interunit delay pseudo-randomly with a probability that will be described below to determine the rank of v;
(The probability that the compiler chooses the intraboard delay is a function of how critical the most critical path containing v appears to be. If v is on long paths it chooses the intraboard delay with high probability. If v is only on short paths, the compiler chooses the intraboard delay only with low probability), wherein, the rank of v is an estimate of how soon v can be evaluated and the compiler also knows the length of the longest path starting at v, whether v is on a path that is close to critical
   computing the minimum path length of v as the maximum driver rank of v plus the back rank of v times the intraunit delay,
   computing the maximum path length of v as the maximum driver rank of v plus the back rank of v times the interunit delay,
   if the minimum path length is greater than or equal to the goal length, using the intraunit delay, but if the maximum path length is at most the goal length, using the interunit delay, otherwise, using the interunit delay the closer the goal length is to the maximum path length.

4. merging u and v if estimated execution time of u and v as computed in step 3 above differ by less than the interunit delay and u drives v.
Using the merged nodes as new nodes partitioning using established means and hyper edges). This completes partitioning and every node has been assigned to a computational unit.

The scheduling method further comprises the steps of:

levelizing evaluation instructions with respect to registers of the design,

folding levels into flights constrained by the processor resources, and

inserting noop instructions to space evaluation instructions within a fold.

The optimization further comprises the steps of: replacing a noop instruction with a non-critical evaluation instruction, balancing the load of evaluation instructions among processors, and minimizing data transfer volume and delay.

The compiler may generate a canvassing instruction when a data transfer requires crossing a unit boundary to transfer results between two evaluation instructions.

The present invention may be tangibly embodied as program instructions on a computer-readable medium for controlling the operation of one or more processors, comprising the steps of

executing program instructions on a plurality of evaluation processors and on a plurality of canvassing processors resulting in the transfer of results of selected evaluation processor evaluations available to and read by selected evaluation processors to perform further evaluations; and

updating one or more circuit signal values, wherein updating comprises the steps of

transferring a circuit signal value,

reading a circuit signal value, and

storing a circuit signal value data in circuit signal value storage media, these steps performed in any order or simultaneously

controlling the transfer of signal values, wherein controlling comprises the steps of

composing canvassing instructions to pass the results of a selected evaluation processor to those evaluation processors which require those results to execute their evaluation instructions

compiling one or more hardware descriptions to processor instructions,

translating the electronic circuit description into executable evaluation instructions, and

analyzing the circuit value transfers inherent to the electronic circuit description.

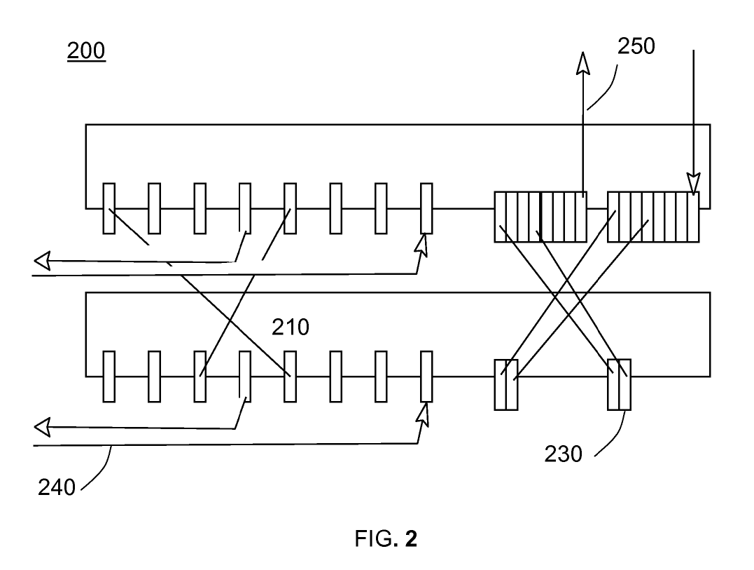

A single-user simulation acceleration verification center comprising a fiber-based interconnection topology 200 is shown in FIG. 2 attached to a plurality of evaluation module units in a chassis and optionally attaching to other evaluation module units of other chassis not shown through high speed serial links 240.

For each of the evaluation module units there may be a plurality of evaluation transmitters and receivers 210 allowing each evaluation module unit to communicate with every other evaluation module unit within its chassis as well as to an evaluation module unit in another chassis. An evaluation module unit may also have a plurality of host transmitters and host receivers 230 and connect to the first evaluation module unit in a chassis and thence to the host through high speed serial links 250.

In an embodiment each evaluation module unit may be attached by a plurality of evaluation transmitter physical links, a plurality of evaluation receiver physical links, a plurality of local evaluation receiver links, a plurality of host transmitter physical links and a plurality of host receiver physical links.

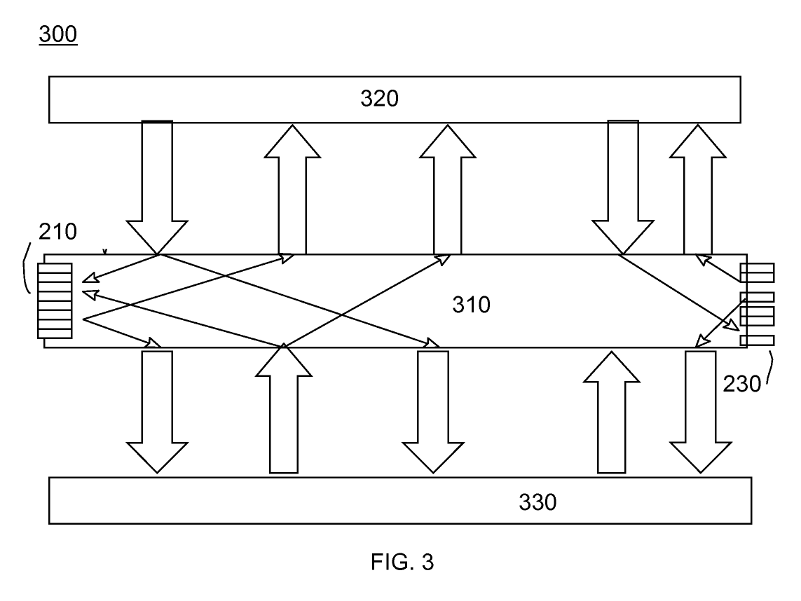

A simulation acceleration appliance 300 is shown in FIG. 3 comprising an interconnect 310 attached by high speed serial links 210 to an evaluation module unit 320 and a second evaluation module unit 330. The high speed serial links may consist of 4 types: evaluation receivers, evaluation transmitters 210 which exchange signal data between the evaluation module units, and host transmitters, and host receivers 230 which may exchange information with an attached workstation.

Evaluation Unit—An embodiment of the present invention further comprises a control processor, a plurality of octal combinational logic operation evaluators, a trace unit and a data unit attached to the interconnect network.

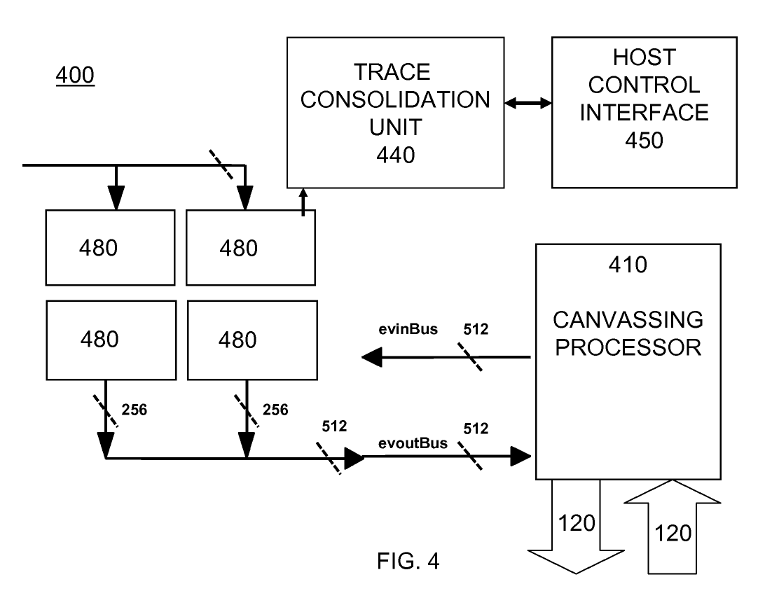

An evaluation module unit 400 shown in FIG. 4 comprising a canvassing processor 410 attached by a 512 bit bus to a plurality of micro octal simulation accelerator integrated circuits 480 attached to a trace consolidation unit 440, the evaluation module unit further comprising a host bus control 450.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

### SUMMARY

The present invention is a method for adapting a design description to a process executable by a plurality of processors in a plurality of units comprising the steps of assigning domains, analyzing critical paths, assigning units, and scheduling; wherein assigning domains comprises dividing a graph representing a design description into at least one of a part controlled by an identifiably distinct clocking entity and a part shared between a second identifiably distinct clocking entity, wherein analyzing critical paths comprises identifying the logic and communication, delay path dependencies of the design description and finding the longest paths in the design description, wherein assigning units comprises allocating a graph element to a processor unit based on a solution of the communication/process allocation constraint problem, and wherein scheduling comprises allocating an instruction and a meta functions to a process slot and to a processor, so as to satisfy the space and time constraints represented in a design graph.

The present invention further comprises the step of optimizing critical paths, wherein optimizing critical paths comprises identifying the logic and communication delay path dependencies of the design description and finding at least one longest path in the design description so as to ensure that the longest path may be kept within a single unit whenever possible.

In the event that the design description contains memories as well as logic, the invention further comprises allocating memory comprising the step of allocating physical memories and assigning a design memory to a physical memory based on constraints such as size (width and depth) and cost of access.

To simulate a large design, it will require more processors than can be located in a single unit with necessary transfer delay between units, therefore the invention has the capability of scheduling interunit communications, comprising selecting the process slots which produce inter-unit data and placing those slots which receive such data.

The method further emits loadable code comprising generating code for the sequencing engine code, constructing a final machine image and writing a file in a form suitable for loading into at least one memory of a unit.

A necessary step is to expand a design description into instructions selected from a list of instructions available to a processor by selecting an instruction for decomposition of design functions into at least one of a hardware instruction, a meta function and a machine operation in one embodiment a memory access, and optimizing using at least one of eliminating dead code, propagating constants, and combining CSE methods.

### CONCLUSION

The present invention addresses the issue of scalability of emulation and simulation of electronic circuits in the design of more complex products in a timely manner.

The present invention provides means for electronics design engineers to efficiently execute instructions compiled from a hardware description language functional model of a hypothetical system prior to fabrication on a plurality of processors.

What is claimed is:

1. A method for compiling a hardware description language description of a circuit to efficient parallel instructions for use in an array of processors comprising the steps of assigning instructions to processors, scheduling instructions in reverse order, optimizing critical paths in the topology of the design, and translating a hardware description of a circuit to a plurality of canvassing instructions and a plurality of evaluation instructions, whereby all evaluations are executed in advance of when their propagated results are required for subsequent evaluations and the circuit is simulated in the least time.

2. A method, for compiling a circuit description to processor instructions, comprising the following steps:
assigning evaluation instructions to certain processors,
wherein assigning comprises the steps of:
packing a non-critical evaluation instruction to replace a noop,
balancing the load of evaluation instructions among processors, and
minimizing data transfer volume and delay;
scheduling instructions in reverse order,
wherein scheduling comprises the steps of:
levelizing evaluation instructions with respect to registers of the design,
folding levels into flights constrained by the processor resources, and
inserting at least one noop to space evaluation instructions within a fold;
optimizing critical paths in the topology of the design,
wherein optimizing comprises the steps of:
estimating the effect of a transfer delay on a critical path,
assembling a fascine of critical paths to optimize data transfer, and
breaking a path not included in a fascine of critical paths; and
translating a hardware description of a circuit to a plurality of evaluation and canvassing instructions.

3. A method comprising the following steps:
assigning an instruction to one of a plurality of processors,
scheduling instructions in reverse order from output to inputs,
heuristically optimizing critical paths in the topology of the design, and
translating a hardware description of a circuit to a plurality of instructions.

4. The method of claim 3 wherein heuristically optimizing critical paths comprises the steps of:
estimating the effect of a transfer delay on a critical path,
assembling a fascine of critical paths to optimize data transfer, and
breaking a path not included in a fascine of critical paths.

5. The transfer delay of claim 4 selected from the group following: uniform transfer delay and a plurality of quantized transfer delay.

6. The method of claim 4 wherein optimizing further comprises selecting an edge of a directed acyclic graph of the design pseudo-randomly, inserting a quanta of delay associated with breaking the path and determining if it becomes a critical path.

7. The optimizing method of claim 6 further comprising measuring the topological interconnection between two critical paths and assigning them to a fascine of critical paths with uniform transfer delay if the potential communication traffic is above average.

8. The method of claim 3 wherein scheduling further comprises the steps of:
levelizing evaluation instructions with respect to registers of the design,
folding levels into flights constrained by the processor resources, and
inserting at least one noop instruction to space evaluation instructions within a fold.

9. The method claim 8 further comprising the steps of:
replacing a noop instruction with a non-critical evaluation instruction,
balancing evaluation instructions among processors, and minimizing data transfer volume and delay.

10. The method of claim 3 wherein an instruction is selected from the group following: canvassing instruction and evaluation instruction.

11. A system, for generating instructions to control a plurality of processors, comprising:
a memory unit that contains stored data files, the data files comprising a hardware description language model of a desired electronic circuit, and
a processor that is in communication with the memory unit; wherein the processor is adapted to perform the following steps: assigning instructions to certain processors,
scheduling instructions in reverse order from output to inputs,
heuristically optimizing critical paths in the topology of the design, and
translating a hardware description of a circuit to instructions.

12. A program product, tangibly embodied as program instructions on a computer-readable medium for controlling the operation of at least one processor, comprising the method of adapting the operation of a plurality of processors as follows:
executing a plurality of program instructions on a plurality of evaluation processors and on a plurality of canvassing processors resulting in the transfer of results of selected evaluation processor evaluations available to and read by selected evaluation processors to perform further evaluations; and
updating at least one circuit signal value,
wherein updating comprises the steps of
transferring a circuit signal value,
reading a circuit signal value, and
storing a circuit signal value data in circuit signal value storage media,
these steps performed in any order or simultaneously.

13. The steps of claim 12 further comprising
controlling the transfer of signal values,
wherein controlling comprises the steps of
composing at least one canvassing instruction to pass a result of a selected evaluation processor to at least one evaluation processor which requires the result to execute its evaluation instruction.

14. The steps of claim 12 further comprising
compiling one or more hardware descriptions to processor instructions,
translating the electronic circuit description into executable evaluation instructions, and
analyzing the circuit value transfers inherent to the electronic circuit description.

15. The method comprising the steps of
selecting instructions adapted to execute on a plurality of evaluation processors, clustering critical paths,
partitioning among a plurality of units, and
scheduling in reverse order.

16. The method of claim 15 wherein selecting instructions comprises building a table of available instruction templates appropriate to the evaluation processor, reading a hardware description of a circuit, and selecting instructions from available instruction templates according to speed, capacity requirements, and cost.

17. The method of claim 15 wherein clustering critical paths comprises creating an uncuttable fascine of related critical paths, assigning a cost to each communication edge between instructions, and tracing from the inputs of every register backward through instructions to an output of a register to identify a critical path with the greatest number of communication edges.

18. The method of claim 15 wherein partitioning among a plurality of units comprises distributing a graph among units and ensuring that send and receive nodes are not on critical paths so as to balance computation across all available hardware resources and to minimize the overall critical path of the system.

19. The method of claim 15 wherein scheduling in reverse order comprises partitioning sending and receiving nodes on critical paths to be close rather than remote, scheduling an instruction for a sending node that must be remote from a receiving node earlier to allow propagation of results and ensuring that every send node is computed before its results are required at a receive node by scheduling in reverse order from outputs to inputs by synthesizing canvassing processor instructions.

20. The method of claim 15 further comprising a critical path optimizing method comprising assigning a cost value to every path, assigning a higher cost value to critical paths, assigning nodes to units, adding additional cost to paths which traverse unit to unit, computing the overall cost to determine if a critical path has been cut, and canceling the assignment if the effect is deleterious.

21. The method of claim 15 further comprising a unit assignment compacting method comprising levelizing evaluation instructions with respect to registers of the design, folding levels into flights constrained by the processor resources, inserting noops to space evaluation instructions within a fold, packing non-critical evaluation instructions to replace noops, grouping signals to be communicated into packets and encoding constraints on the netlist on the order in which packets are sent so as to ensure that the transmission ordering constraint imposed by the order in which signals are received does not conflict with other constraints on computing the order in which signal transmit whereby the compiler can schedule backward in time by grouping signals that are to be received together before determining exactly when they will be sent.

22. The method of claim 15 further comprising estimating transfer delay comprising one of uniform transfer delay or a plurality of quantized transfer delay comprising the steps of selecting an edge of a directed acyclic graph of the design pseudo-randomly, inserting a quanta of delay associated with breaking the path, determining if it becomes a critical path, measuring the topological interconnection between two critical paths, and assigning both paths to a fascine of critical paths with uniform transfer delay if the potential communication traffic is above average.

23. The method of claim 15 further comprising a meta function evaluation method comprising selecting an evaluation with input width greater than the capacity of a single processor, assigning the evaluation to a canvassing processor, setting an address of a canvassing processor storage to one of the possible input values of the evaluation, and storing a result of a meta function evaluation into the canvassing processor storage so as to cause retrieval of a result of a meta function evaluation from a canvassing processor storage by applying the evaluation inputs as the address of a canvassing processor storage.

24. A method for adapting a design description to a process executable by a plurality of processors in a plurality of units comprising the steps of assigning domains, analyzing critical paths, assigning units, and scheduling
wherein assigning domains comprises dividing a graph representing a design description into at least one of a part controlled by
an identifiably distinct clocking entity and a part shared between a second identifiably distinct clocking entity,
wherein analyzing critical paths comprises identifying the logic and communication delay path dependencies of the design description and finding the longest paths in the design description,
wherein assigning units comprises allocating a graph element to a processor unit based on a solution of the communication/process allocation constraint problem, and
wherein scheduling comprises allocating one of an instruction and a meta function to a process slot and to a processor, so as to satisfy the space and time constraints represented in a design graph.

25. The method of claim 24 further comprising the step of optimizing critical paths, wherein optimizing critical paths comprises identifying the logic and communication delay path dependencies of the design description and assigning at least one longest path in the design description so as to ensure that the longest path may be kept within a single unit whenever possible.

26. The method of claim 25 further comprising allocating memory comprising the step of allocating physical memories and assigning a design memory to a physical memory based on constraints such as size (width and depth) and cost of access.

27. The method of claim 26 further comprising scheduling interunit communications, comprising selecting the process slots which produce inter-unit data and placing those slots which receive such data.

28. The method of claim 27 further comprising emitting loadable code comprising generating code for the sequencing engine code, constructing a final machine image and writing a file in a form suitable for loading into at least one memory of a unit.

29. The method of claim 24 further comprising selecting an instruction for decomposition of design functions into at least one of a hardware instruction, a meta function and a machine operation.

30. The method of claim 29 wherein a machine operation is a memory access, and wherein optimizing comprises using at least one of eliminating dead code, and propagating constants methods.
